(19) United States
(12) Patent Application Publication
(10) Pub. No.: US 2024/0317410 A1
(43) Pub. Date: Sep. 26, 2024

(54) "G" Load Suppressing Aircraft

(71) Applicant: Harold Wright, White City, KS (US)

(72) Inventor: Harold Wright, White City, KS (US)

(21) Appl. No.: 18/653,441

(22) Filed: May 2, 2024

Related U.S. Application Data
(63) Continuation-in-part of application No. 18/211,379, filed on Jun. 19, 2023.
(60) Provisional application No. 63/464,093, filed on May 4, 2023.

(51) Int. Cl. B64D 25/12; B64C 1/14; B64D 17/80

(52) U.S. Cl. CPC B64D 25/12; B64C 1/1476; B64D 17/80

(57) ABSTRACT

A “G” load suppressing aircraft incorporating a fuselage having a nose end; a cavity, extending downwardly into the fuselage, the cavity opening upwardly at the fuselage's nose end; a cockpit capsule fitted for receipt within the cavity; explosive bolts for releasably attaching the cockpit capsule to the fuselage, the explosive bolts holding the cockpit capsule within the cavity; a liquid supply line for filling the cockpit capsule with a transparent liquid, the liquid supply line being connected operatively to the cockpit capsule; and rocket engines for ejecting the cockpit capsule from the cavity, the rocket engines being connected operatively to the cockpit.

### CLAIM OF BENEFIT OF PREVIOUSLY FILED APPLICATIONS

The instant application constitutes a continuation in part of U.S. patent application Ser. No. 18/211,379, filed Jun. 19, 2023 entitled “Crew Safety Cockpit”. Said earlier application Ser. No. 18/211,379 claimed the benefit of and filing date of U.S. Provisional Patent Application No. 63/464,093, filed May 4, 2023, also entitled “Crew Safety Cockpit”. The instant application further claims the filing date of and benefit of said '093 Provisional Patent Application. The Inventor and Applicant of the instant application is the same as the Inventor and Applicant of said '397 and '093 applications.

### FIELD OF THE INVENTION

This invention relates to high performance aircraft or fighter jet aircraft. More particularly, this invention relates to such aircraft which are adapted for protecting a pilot from excess G-loads during aircraft maneuvers.

### BACKGROUND OF THE INVENTION

During operation of their aircraft, jet fighter pilots often experience extreme forces directed against their bodies in the form of thrust accelerations and centripetal accelerations. During a forward thrust acceleration exerted by an aircraft against the pilot, forwardly directed pressure is applied to pilot's upper and lower back, often resulting in bodily volumetric distention at the dorsal aspects of pilot's upper and lower back. During centripetal acceleration imposed by the aircraft upon the pilot, for example upon pulling out of a steep dive, centripetal force drives the pilot downwardly within the cockpit, resulting in downward distention of the body.

An adverse effect of such acceleration induced bodily distention includes blood flow in the direction of the bodily distention, resulting in blood pressure and blood volume hypotension within the pilot's cranium. Cranial hypotension in its milder forms may make the pilot feel dizzy or faint. Progression and worsening of such hypotension during increased acceleration induced body distention may progressively result in loss of vision, and loss of consciousness.

A known method for accommodating and ameliorating acceleration force induced body distention and resultant orthostatic cranial hypotension includes provision of an air pressure actuated G-suit or anti G-suit. However, such protective suits are only capable compensating for approximately 9 G's of force, and then only during a short time period and with great pilot discomfort. Modern fighter aircraft are capable of performing maneuvers which would impose in excess of 9 G's upon the pilot. Conventional air pressure actuated G-suits are typically incapable of compensating for such G-forces.

Another known method for compensating for aircraft maneuver-imposed G-loads upon a pilot's body includes immersion of the pilot within a transparent liquid filled chamber carried within the aircraft. Such liquid filled chambers are capable of evenly distributing maneuver induced G-forces in the form of constant hydrostatic pressure at all surfaces of the pilot's body. Such fluid dispersed and evenly distributed hydrostatic pressure advantageously buoyantly supports the pilot, thereby reversing or counteracting G-force or G-load induced bodily distension. Such body immersion mode of G-force compensation is typically more effective than the above-described air pressure actuated G-suits. However, such immersion systems are commonly incompatible with or interfere with pilot ejection during an aircraft emergency.

The instant inventive G-load suppressing aircraft solves or ameliorates such problems and deficiencies by modifying a high performance aircraft to include a specialized cockpit capsule adapted for G-force compensating body immersion.

### OBJECT AND SUMMARY OF THE INVENTION

The instant inventive G-load suppressing aircraft suitably incorporates conventional high-performance aircraft or fighter jet components including a fuselage, left and right wings which support left and right ailerons, a tail rudder, and tail elevator fins. A further structural component of the instant inventive aircraft comprises a cavity or void which extends downwardly into an upper end of the fuselage and opens upwardly. In a preferred embodiment, the cavity component is positioned at the nose end of the aircraft, such cavity substantially occupying the cockpit space of a conventional fighter jet.

A further structural component of the instant inventive aircraft comprises a cockpit capsule which is fitted for nesting receipt within the cavity. In a preferred embodiment, the cockpit capsule comprises a lower rigid basin and an upper canopy. The canopy is preferably openable and closable, and is capable of hermetically sealing the basin's upper opening.

Further structural and functional components of the instant inventive aircraft comprise means for releasably attaching the cockpit capsule to the fuselage, said means preferably holding the cockpit capsule within the cavity. In a preferred embodiment, such means comprise a plurality of electrically actuated explosive bolts which releasably attach the capsule's rigid basin component to the aircraft's fuselage frame.

Further structural components of the instant inventive aircraft comprise means for filling the cockpit capsule with a transparent liquid such as water. In a preferred embodiment, such means comprise a reservoir mounted within the fuselage and a matrix of conduits for exchanging liquid between the cockpit capsule and the reservoir.

Further structural components of the instant inventive aircraft comprise respiration gas supply means which are operatively installed within the cockpit capsule.

Further structural components of the instant inventive aircraft comprise means for ejecting the cockpit capsule from the cavity. In a preferred embodiment such means comprise a plurality of rocket engines operatively mounted to an undersurface of the rigid basin.

In operation of the instant inventive aircraft, the aircraft's pilot may seat himself or herself upon a seat within the cockpit capsule. Following closure of a provided hermetically sealing cockpit canopy, the means for filling the cockpit capsule with the transparent liquid may be actuated to substantially completely fill the cockpit. The air supply means are simultaneously actuated to sustain the pilot's respiration during flight operations within the liquid filled capsule.

Thereafter, the aircraft may, for example, execute a high G turn. During the turn, the liquid environment of the cockpit capsule compensates for and ameliorates the undesirable effects of high G-forces upon the pilot's body. Where, for example, the weight:body volume ratio of the pilot is 2 percent greater than the weigh per unit volume of the transparent liquid, and where the pilot weighs 200 pounds, the pilot would effectively “feel” only approximately 4 pounds of pressure at the pilot's contacts with the seat during normal 1G aircraft operation. During a high G turn imposing, for example, 9G's of force upon the aircraft's wings and fuselage, such liquid immersed pilot would “feel” only 36 pounds of multiplied G-force, such force gently urging the pilot into his seat. In contrast, with no anti-G protection, such pilot would “feel” approximately 1,800 pounds of force during the 9G maneuver. The differential in perceived G-forces which is advantageously provided by the instant inventive aircraft results from the buoyancy effect of the transparent liquid within the cockpit capsule. The instant invention's liquid cockpit environment substantially eliminates body distension during high G maneuvers, advantageously eliminating pilot blackouts.

In the event of a midair emergency, the pilot may actuate the aircraft's cockpit capsule ejecting system to upwardly extract the liquid filled cockpit capsule from the aircraft's cavity. Such ejecting means' preferably incorporate rocket engines which swiftly and forcefully upwardly remove the cockpit capsule from the cavity. During execution of such cockpit capsule ejection function, the above-described buoyancy effected reduction of felt G-forces accommodates and effectively ameliorates any excess G-forces resulting from the ejection rocket's thrust.

The instant inventive G-load suppressing aircraft preferably further comprises a parachute for facilitation of a survivable landing following such rocket propelled capsule ejection. Upon landing upon a hard surface, the above-described buoyancy effect of the capsule's transparent liquid environment ameliorates and cushions the effects of a hard parachute assisted landing. Upon a water landing, the inventive cockpit capsule may effectively function as a life boat.

Accordingly, objects of the instant invention include the provision of a G-load suppressing aircraft which incorporates structures as described above, and which arranges those structures in relation to each other in manners described above for the performance of an achievement of beneficial functions as described above.

Other and further objects, benefits, and advantages of the instant invention will become known to those skilled in the art upon review of the detailed description which follows, and upon review of the appended drawings.

### BRIEF DESCRIPTION OF DRAWINGS

FIG. 1 is a right-side plan view of the instant inventive G-load suppressing aircraft.

FIG. 2 is an upper plan view of the aircraft of FIG. 1.

FIG. 3 is a front view of the aircraft of FIGS. 1 and 2.

FIG. 4 re-depicts the structure of FIG. 3, the view of FIG. 4 showing a cockpit capsule component immediately following ejection.

FIG. 5 presents a magnified view of the cockpit capsule of FIG. 4.

FIG. 6 is a sectional view of the cockpit capsule of FIG. 5, as indicated in FIG. 3.

FIG. 7 re-depicts the structure of FIG. 6, the view of FIG. 7 showing the cockpit capsule filled with a transparent liquid.

### DETAILED DESCRIPTION OF THE INVENTION

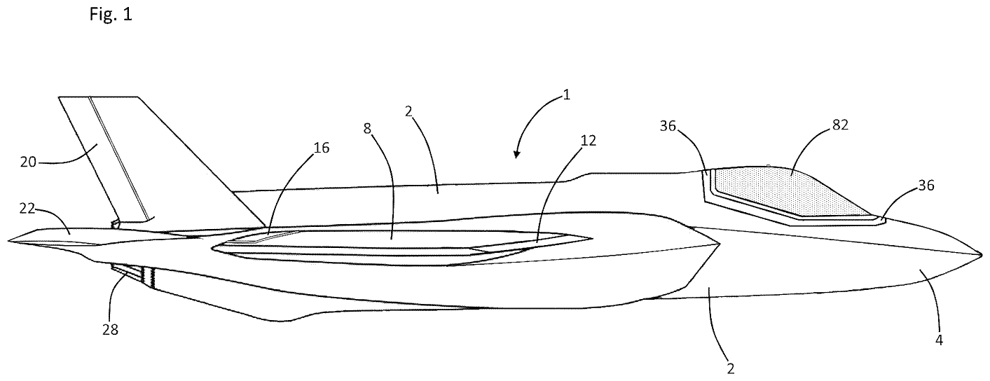

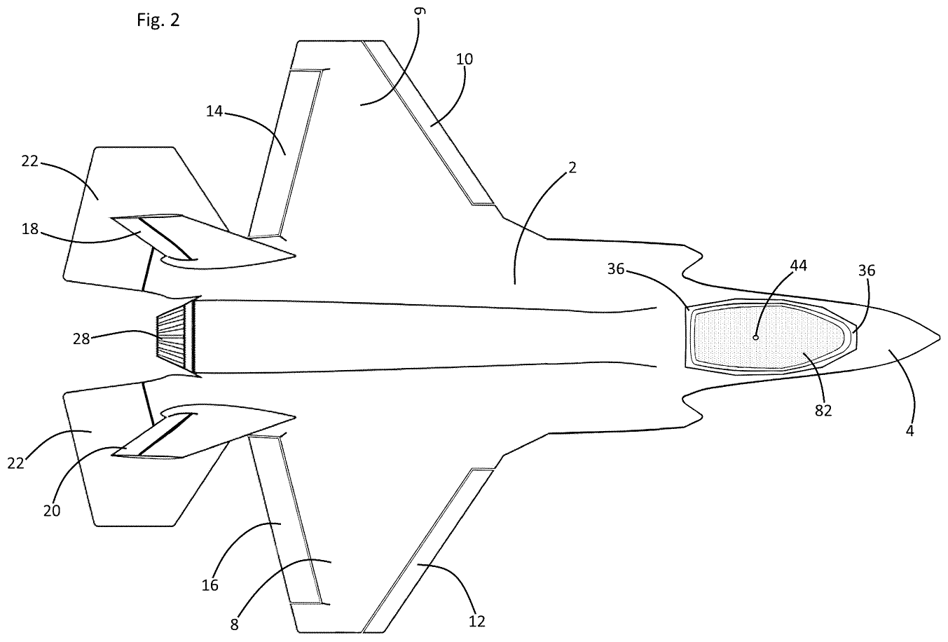

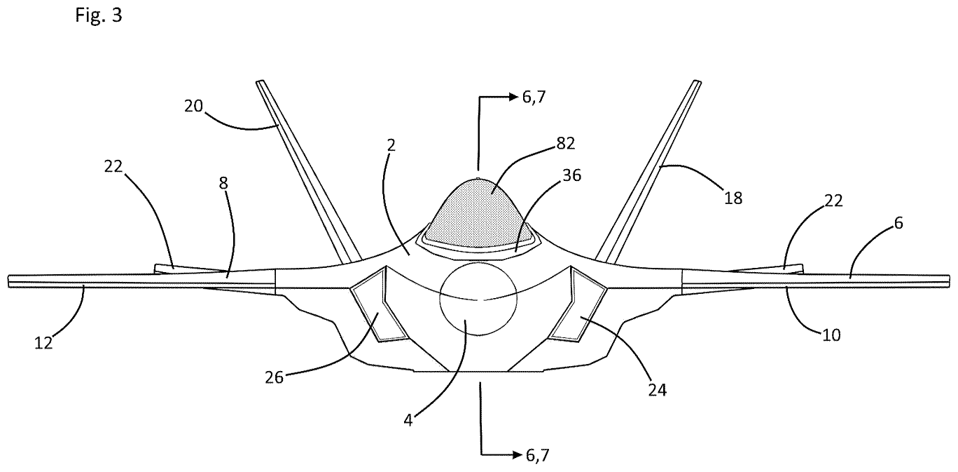

Referring now to the drawings, and in particular, simultaneously to FIGS. 1-4, a G-load suppressing aircraft configured in accordance with the instant invention is referred to generally by reference arrow 1. The aircraft 1 has a fuselage 2 having a nose end 4, left and right wings 6 and 8 having leading edge flaps 10 and 12 and having left and right ailerons 14 and 16, left and right tail rudders 18 and 20, tail stabilizers/elevators 22, left and right jet engine air intake ports 24 and 26, and a rear thrust port 28. The instant inventive aircraft preferably further comprises a cavity, void, or opening 30 which extends downwardly into the nose end 4 of the fuselage 2. A cockpit capsule referred to generally by reference arrow 32 is provided, such capsule being fitted for downward insertion into and nesting receipt within the cavity 30.

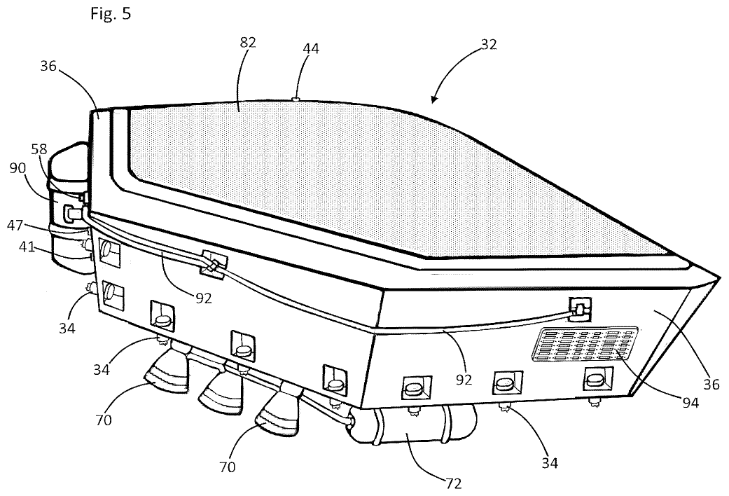

Referring further to FIG. 5, the instant inventive G-load suppressing aircraft preferably further comprises means for releasably attaching the cockpit capsule 32 to the fuselage 2. In a preferred embodiment, such means comprise a plurality of explosive bolts or pyrotechnic fasteners 34. During normal operations, such fasteners 34 rigidly attach and position the cockpit capsule 32 within the fuselage cavity 30, such bolts rigidly connecting with the fuselage's interior frame members (not depicted within views). Such explosive bolts suitably are of the type which include an embedded pyrotechnic mixture such as RDX, a nitrocellulose based explosive, or a potassium perchlorate based explosive. Such explosive bolts are preferably simultaneously electrically actuatable to achieve a coordinated and stable release of the cockpit capsule 32 from the fuselage 2.

In a preferred embodiment, the lower portion of the cockpit capsule 32 comprises a substantially ridged basin 36 which is composed of lightweight aluminum. The explosive bolt attachments 34 of such basin component 36 to the fuselage's frame members preferably normally incorporate the rigid basin as a structural frame component. During normal operation of the aircraft, the interposition of cavity 30 within the fuselage 2 does not significantly structurally compromise the forward frame matrix of the aircraft because the basin itself functions as a fuselage frame member in addition to performance of G-load suppression.

While the explosive bolts 34 constitute a preferred means for releasably attaching the cockpit capsule 32 to the fuselage 2, other releasable attaching means such as solenoid actuated slide bolts or servomotor actuated screw fasteners (not depicted within views) may be suitably substituted.

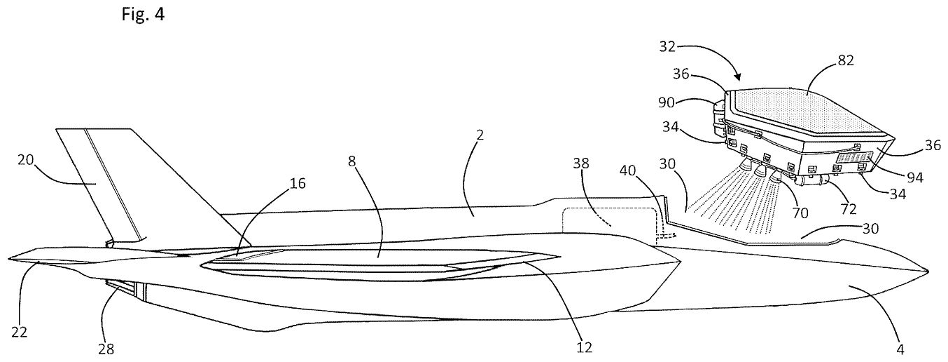

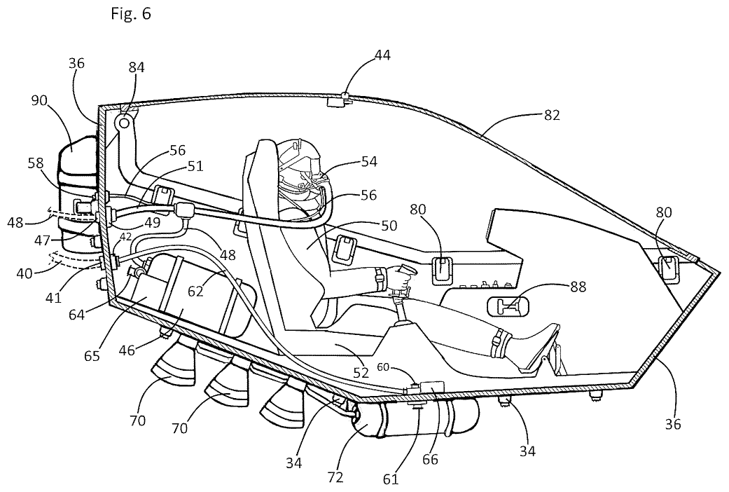

Referring simultaneously to FIGS. 4, 6, and 7, the instant inventive aircraft preferably further comprises means for filling the cockpit capsule 32 with a transparent liquid such as water. In a preferred embodiment, such means comprise a reservoir 38 mounted within the fuselage 2 rearwardly from the capsule receiving cavity 30. Such reservoir 38 is served by a supply line or conduit 40 which communicates with a liquid input port 41, 42, such port opening the capsule 32 at its rear wall. A fluid pump (not depicted within views) mounted within the fuselage 2 may pump the transparent liquid from the reservoir 38 through conduit 40 to emit within the interior of the cockpit capsule 32, such fluid flowing through port 41, 42, then through conduit 62, to emit into the capsule's interior via a fill port 60 of a selector valve 66. In a suitable, though less desirable alternative, the transparent liquid may be supplied from an outside source, such as a tank truck which pumps the liquid directly into the cockpit capsule.

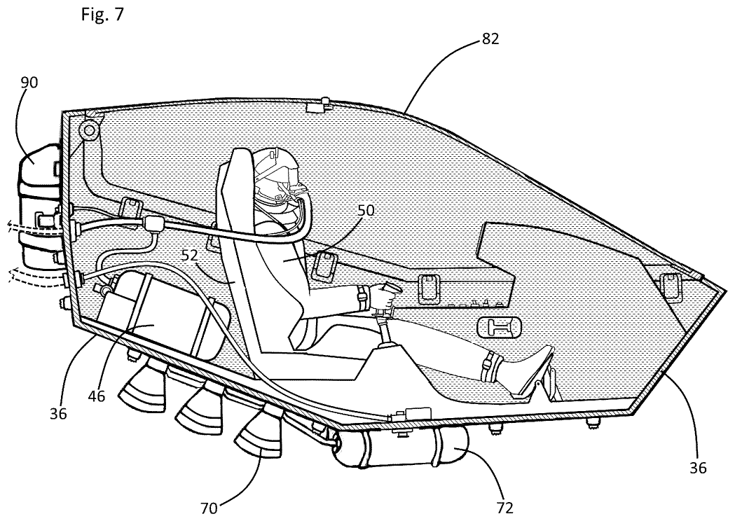

Upon opening of an upper air relief valve 44 within canopy 82, the transparent liquid emitted from port 60 may completely fill the cockpit capsule 32 with the transparent liquid, as indicated in FIG. 7. Upon the complete filling of the cockpit capsule the air relief valve 44 may be closed, hermetically sealing and capturing the liquid within the cockpit capsule. In a preferred embodiment, the transparent liquid may comprise water. Suitably, the transparent liquid may alternatively comprise an electrically nonconductive or dielectric liquid such as mineral oil. Where the transparent liquid comprises water, electrical components exposed within the cockpit capsule 32 are preferably insulated against contacts with electrically conductive water. A transparent substitution of a dielectric liquid may advantageously lessen requirements for electrically insulating interior electronic components. The pilot 50 is shown wearing a hermetically enveloping bodysuit and helmet, which may protect the pilot from contact with the liquid.

The instant inventive G-load suppressing aircraft preferably further comprises respiration gas supply means which are connected operatively to the cockpit capsule 32. In a preferred embodiment, such gas supply means comprise an interior compressed gas bottle or tank 46 and supply line 48, in combination with exterior respiration gas supply lines 48 and 49. During normal aircraft operation, air supply via a fuselage mounted gas compressor or tank (not depicted within views) supplies respiration gas to an intake port 47,49. An air line 51 air extending from port 47,49 provides respiration gas to the pilot 50 seated in seat 52 within the cockpit capsule 32.

Air from the capsule mounted compressed air bottle 46 and gas supply line 48 extending therefrom may alternatively supply air to the pilot 50. Respiration gas from line 51 or 48, as the case may be, communicates with the pilot's face mask or hermetically sealed helmet 54. The pilot's exhaled gas exits the capsule at an outlet port 58 via return airline 56. Accordingly, the pilot's exhaled breath exits the capsule 32 at port 58 rather than accumulating within the capsule's interior.

The selector valve 66 mounted at a lower end of the capsule 32 may receive the transparent liquid from reservoir 38 via conduit 40, via port 41, 32, and supply line 62. Accordingly, liquid pumped from the reservoir 38 may fill the interior of the capsule 32 from its lower end. During such capsule filling, the upper air relief port 44 is preferably opened to emit air displaced by the liquid. The selector valve 66 may include a setting which purges the liquid by permitting air emitting from the compressed gas bottle 46 at outlet port 64 to displace the liquid within capsule 32, driving the liquid rearwardly through supply line 62. Such gas displacement liquid purging of the interior of the capsule may advantageously refill the fuselage mounted reservoir 38. During such gas displacement refilling of reservoir 38, relief valve 44 preferably remains closed. Further alternatively the selector valve 66 may include a setting allowing the released gas from bottle 46 to displace the liquid downwardly and outwardly through a liquid purge port 66.

The instant inventive G-load suppressing aircraft preferably further comprises means for ejecting the cockpit capsule 32 from the cavity 30. In a preferred embodiment, such means comprise a plurality of rocket engines 70 operatively mounted at a lower end of the capsule's basin 36. A basin mounted liquid propellant tank 72 may be provided for supplying combustion fuel to the engines 70. Alternatively, such engines may comprise solid fuel rocket thrusters. While a provision of a rocket-based cockpit capsule ejecting means is preferred, other ejecting means such as spring-loaded ejectors, hydraulically actuated ejectors, or pneumatically actuated ejectors (not depicted within views) may be suitably substituted.

In operation of the instant invention's pilot immersing cockpit capsule 32, canopy latches 80 may be initially released, and the capsules' upper canopy 82 may be initially raised pivotally about canopy hinges 84. Thereafter, the pilot 50 may enter the cockpit capsule 32, and may be seated upon seat 52. Thereafter, the canopy 82 may be closed and latches 80 may be actuated to hold the canopy as a hermetically sealed or closure over the upper opening of the lower basin 36.

Thereafter, air relief valve 44 may be opened and selector valve 66 may be operated to open fill port 60. Thereafter, the transparent liquid may be pumped from reservoir 38 through line 40, then through port 41,42, and then through line 62 to emit at fill port 60. Accordingly, liquid from reservoir 38 may completely fill the interior of the capsule as indicated in FIG. 7. Prior to liquid filling, the pilot 50 may don a face mask or helmet 54 for receipt of respiration gas from gas lines 48 and 51. Upon complete filling of the capsule, relief valve 44 may be closed and selector valve 66 may be operated to close fill port 60.

In the event of an air emergency such as loss of engine power, the pilot 50 may pull an ejection sequence actuation handle 88. Such actuation initially electrically triggers explosive bolts 34, effectively severing the bolts and releasing the capsule basin 36 from its bolted integration with the aircraft's forward frame members. Substantially simultaneously, such pull against handle 88 actuates a supply of rocket fuel from propellant tank 72, and fires rocket engines 70. As shown in FIG. 4, thrust from rockets 70 effectively separates the cockpit capsule 32 from the fuselage 2.

The actuation of the aircraft's ejection sequence preferably successively releases a parachute 90, which is normally supported at the rear of the basin 36. Upon parachute deployment, the cockpit capsule 32 suspends in a level orientation from chute lines 92. In the event of a low altitude ejection, rocket engines 70 preferably extend their operation, raising the cockpit capsule 32 to an altitude sufficient for parachute deployment.

The liquid supply line 40 and the air supply line 48 preferably attach to the capsule at break-away connector components 41 and 47 of ports 42 and 49. Break-away or releasable electrical contact sockets or terminals 94 may be similarly provided, such contacts allowing for ejection actuated separations of the normally electrically connected junctures between the capsule's interior electrical components and electronic components housed within the fuselage 2. Upon execution of the above-described ejection sequence, such break away connectors 41, 47, and 94 advantageously facilitate a clean and uninterrupted separation of the capsule 32 from the fuselage 2.

To exit the fluid filled cockpit capsule 32, the pilot may operate selector valve 66 to open port 60 for receipt of fluid, and may simultaneously operate a respiration gas bottle selector valve 65 to release compressed respiration gas from port 64 into the interior of the capsule. Upon such gas release, the gas displaces the liquid, driving the liquid rearwardly through lines 62 and 40, to refill the liquid reservoir 38. Alternatively, in the event of a capsule ejection followed by a parachute assisted landing, the pilot may actuate selector valve 66 to open ports 60 and 61 while blocking flow through line 62. Upon such alternative selector valve setting, the gas emitting from bottle 46 may displace the liquid outwardly and downwardly through port 61. Alternatively, the gas from bottle 46 may alternatively rearwardly eject the liquid from port 41, 42, via line 62.

Upon a parachute assisted water landing following an emergency ejection of the cockpit capsule 32, and upon submersion of the capsule within a body of water, operation of the gas bottle 46 and selector valves 65 and 66 to displace the liquid within the capsule with gas may advantageously buoyantly raise the capsule to the surface. Notwithstanding, the pilot may choose to delay such buoyant capsule raising and to remain submerged for a period of time. By remaining submerged within the body of water, the pilot may avoid exposing the capsule and himself to a hostile party. Accordingly, while the capsule remains submerged, it may effectively function as a pilot protecting submersible capsule. Upon buoyantly rising to the surface, the cockpit capsule may further advantageously function as a pilot protecting lifeboat. In the preferred embodiment, battery powered emergency radio communication equipment is incorporated into the cockpit capsule 32.

Upon purging of the immersion liquid from the cockpit capsule, canopy latches 80 may be released, the canopy 82 may be opened, and the pilot 50 may exit the capsule.

While the principles of the invention have been made clear in the above illustrative embodiment, those skilled in the art may make modifications to the structure, arrangement, portions, components, and method steps of the invention without departing from those principles. Accordingly, it is intended that the description and drawings be interpreted as illustrative and not in the limiting sense, and that the invention be given a scope commensurate with the appended claims.

1. A “G” load suppressing aircraft comprising:
a. a fuselage having a nose end;
b. a cavity, extending downwardly into the fuselage, said cavity opening upwardly at the fuselage's nose end;
c. a cockpit capsule fitted for receipt within the cavity;
d. means for releasably attaching the cockpit capsule to the fuselage, said means holding the cockpit capsule within the cavity;
e. means for filling the cockpit capsule with a transparent liquid, said means being connected operatively to the cockpit capsule, and;
f. means for ejecting the cockpit capsule from the cavity, said means being connected operatively to the cockpit capsule.

2. The “G” load suppressing aircraft of claim 1, wherein, the cockpit capsule comprises a basin and a canopy overlying the basin, the canopy being adapted for movements between an open position and a closed position, the canopy permitting a pilot's entry into the cockpit capsule upon movement to the open position, the canopy hermetically closing the cockpit capsule upon movement to the closed position.

3. The “G” load suppressing aircraft of claim 2, further comprising respiration gas supply means connected operatively to the cockpit capsule, said means being adapted for conveying air to the pilot within the cockpit capsule.

4. The “G” load suppressing aircraft of claim 3, wherein, the means for ejecting the cockpit capsule comprise at least a first rocket engine.

5. The “G” load suppressing aircraft of claim 4, further comprising at least a first parachute connected operatively to the cockpit capsule.

6. The “G” load suppressing aircraft of claim 5, wherein the means for releasably attaching the cockpit capsule to the fuselage comprise a plurality of explosive bolts.

7. The “G” load suppressing aircraft of claim 6, further comprising a reservoir and fluid conduit combination, said combination's reservoir being supported within the fuselage, said combination's fluid conduit being adapted for conveying the transparent liquid between the cockpit capsule and said reservoir.

8. The “G” load suppressing aircraft of claim 7, wherein, the respiration gas supply means comprise a compressed air bottle mounted within the cockpit capsule.

9. The “G” load suppressing aircraft of claim 8, wherein, the respiration gas supply means comprise a face mask and air tubes combination, said combination's facemask being adapted for covering the pilot's mouth and nose, and said combination's air tubes being adapted for carrying the gas to and from the pilot's mouth and nose.

10. The “G” load suppressing aircraft of claim 9, further comprising a plurality of electric terminals, said terminals being adapted for, upon operation of the means for ejecting the cockpit capsule from the capsule, releasing electrical connections between fuselage and the cockpit capsule.

11. The “G” load suppressing aircraft of claim 10, wherein, the transparent liquid comprises a fluid selected from the group consisting of water and a dielectric liquid.

12. The “G” load suppressing aircraft of claim 11, further comprising an air purge valve, said valve being connected operatively at an upper end of the canopy.

13. The “G” load suppressing aircraft of claim 12, further comprising a liquid purge valve, said valve being connected operatively at a lower end of the basin.
